(19) United States
(12) Patent Application Publication
(10) Pub. No.: US 2024/0118676 A1
(43) Pub. Date: Apr. 11, 2024

(54) SEGMENTED INDUSTRIAL CONTROL SYSTEM ARCHITECTURE AND RELATED METHODS

(71) Applicant: VirTeca, LLC, Peachtree Corners, GA (US)

(72) Inventors: Christopher James Long, Decatur, GA (US); Charles T. Lane, Suwanee, GA (US); Ott Miidla, Peachtree Corners, GA (US)

(73) Assignee: VirTeca, LLC, (omitted)

(21) Appl. No.: 18/234,182

(22) Filed: Aug. 15, 2023

Related U.S. Application Data
(60) Provisional application No. 63/413,743, filed on Oct. 6, 2022.

(51) Int. Cl. G05B 19/414

(52) U.S. Cl. CPC G05B 19/414; G05B 2219/33139

(57) ABSTRACT

A machine segment in an industrial control system, comprising (1) a control system comprising at least a logic controller and safety controller; (2) safety components; (3) motors; and (4) input/output devices. In particular embodiments: (1) the control system is in network communication with a neighboring machine segment via a first network connection; (2) the safety controller is in network communication with a neighboring machine segment safety controller via a second network connection; (3) the logic controller receives input/output data from the input/output devices and transmit it directly to the neighboring machine segment; (4) the logic controller receives second input/output data from the neighboring machine segment; (5) the logic controller receives identifying data for the neighboring machine segment; and (6) the logic controller controls operation of each of the motors based on one or more of the input/output data, the second input/output data, or the identifying data.

### CROSS-REFERENCE TO RELATED APPLICATION

This application claims the benefit of priority to U.S. Provisional Patent Application No. 63/413,743 filed Oct. 6, 2022, which is hereby incorporated by reference in its entirety for all purposes.

### BACKGROUND

Conventional industrial control systems may include a configuration of machines that are typically designed with an architecture that includes a centralized motor control center (MCC) that controls the functioning of each of the machines found in the system. Such an architecture can prove technically challenging with respect to adding new machines to the system, making scalability a significant problem. In addition, the physical requirements make scalability a technical challenge in that each machine (e.g., motor thereof) requires conduit from the MCC.

### SUMMARY

An industrial control system, according to various embodiments, comprises a plurality of machine segments. In some embodiments, the plurality of machine segments comprise a first machine segment comprising: (1) a segment control system comprising at least a logic controller and an independent safety controller; (2) one or more safety components; (3) one or more motors; and (4) one or more input/output devices. In some aspects: (1) the segment control system in communication with one or more safety components, one or more motors, and one or more input/output devices; and (2) the first machine segment is in direct network communication with a second machine segment of the plurality of machine segments. In particular aspects, the segment control system is configured for: (1) transmitting, to the second machine segment, first function data for the first machine segment; (2) receiving, from the second machine segment, second function data for the second machine segment; (3) receiving, from the second machine segment, identifying data for a gateway computing system in the industrial control system; (4) controlling operation of the one or more motors independent of the plurality of machine segments; (5) receiving input/output data from the one or more input/output devices; (6) monitoring, using the independent safety controller, the one or more safety components; (7) receiving, from at least one of the second machine segment or the gateway computing system, handling data for a particular item traversing the industrial control system; and (8) operating the one or more motors based on the handling data.

In some aspects, the logic controller is configured for performing each of: (1) transmitting, to the second machine segment, the first function data for the first machine segment; (2) receiving, from the second machine segment, the second function data for the second machine segment; (3) receiving, from the second machine segment, the identifying data for a gateway computing system in the industrial control system; (4) controlling the operation of the one or more motors independent of the plurality of machine segments; and (5) receiving the input/output data from the one or more input/output devices. In some aspects, the segment control system is further configured for: (1) receiving, from at least one of the one or more safety components, the second machine segment, or the gateway computing system, an identification of a safety event; and (2) in response to receiving the identification of the safety event, causing, by the independent safety controller, a safety response defined by the safety event.

In various embodiments, the one or more motors comprise one or more motor controllers, and the one or more motor controllers are configured to operate the one or more motors based on at least one of the input/output data, the second function data for the second machine segment, or the handling data. In a particular embodiment, the first machine segment is in direct network communication with the second machine segment via a second direct cable run from the second machine segment. In some aspects, the segment control system is further configured for transmitting the input/output data to the second machine segment. In various embodiments: (1) the second function data for the second machine segment comprises a motor speed for the second machine segment; and (2) the segment control system is further configured for: (A) determining a coordinating motor speed based on the motor speed for the second machine segment; and (B) causing the one or more motors to run at the coordinating motor speed.

In some aspects, the gateway computing system comprises at least one of the second machine segment or a third machine segment of the plurality of machine segments. In other aspects, the industrial control system does not comprise a centralized motor control center.

A machine segment in an industrial control system, in various embodiments, comprises: (1) a segment control system comprising at least a logic controller and an independent safety controller; (2) one or more safety components; (3) one or more motors; and (4) one or more input/output devices. In particular embodiments: (1) the segment control system is in direct network communication with a neighboring machine segment control system via a first network connection; (2) the independent safety controller is in direct network communication with a neighboring machine segment independent safety controller via a second network connection; (3) the logic controller is configured to receive input/output data from the one or more input/output devices and transmit the input/output data directly to the neighboring machine segment control system via the first network connection; (4) the logic controller is configured to receive second input/output data from the neighboring machine segment via the first network connection; (5) the logic controller is configured to receive identifying data for the neighboring machine segment from the neighboring machine segment via the first network connection; and (6) the logic controller is configured to control operation of each of the one or more motors based on one or more of the input/output data, the second input/output data, or the identifying data for the neighboring machine segment.

In some aspects, the logic controller is further configured for: (1) receiving, from the neighboring machine segment via the first network connection, identifying information for a gateway computing system in the industrial control system; (2) receiving, from the gateway computing system, handling data for an item traversing the industrial control system; and (3) modifying the operation of each of the one or more motors based on the handling data at a time that corresponds to the item encountering the machine segment. In some aspects, the neighboring machine segment is the gateway computing system. In particular embodiments, the independent safety controller is configured for: (1) receiving, from at least one of the neighboring machine segment independent safety controller via the second network connection or the one or more safety components, safety event data; and (2) initiating, in response to receiving the safety event data, an emergency event response based on the safety event data. In various aspects, the emergency event response comprises at least one of transmitting the safety event data to a second machine segment via a third network connection or modifying the operation of each of the one or more motors based on the safety event data.

In some aspects: (1) the industrial control system defines a first set of interlocked machine segments and a second set of interlocked machine segments; (2) the machine segment is in the first set of interlocked machine segments; (3) the logic controller is configured to receive operation data directly from each of the first set of interlocked machine segments; and (4) the logic controller is configured to control the operation of each of the one motors in coordinate each of the first set of interlocked machine segments based on the operation data. In some aspects, the first network connection and the second network connection are disposed adjacent an outer side of the machine segment. In some aspects, the machine segment further comprises a shroud that encloses at least a portion of the outer side of the machine segment, shielding a first network connection point for the first network connection and a second network connection point for the second network connection. In particular embodiments, the first network connection is the second network connection.

An industrial control system machine segment, in particular embodiments, comprises: (1) a segment control system comprising a safety controller, one or more power components, and a programmable logic controller; (2) one or more safety components in communication with the safety controller; (3) one or more motors in communication with the programmable logic controller, the one or more motors comprising one or more motor controllers; and (4) one or more input/output devices in communication with the programmable logic controller, the one or more input/output devices comprising one or more sensors and at least one input/output coupler providing a link between the one or more sensors and the programmable logic controller. In particular embodiments: (1) the programmable logic controller is in direct network communication with a corresponding programmable logic controller for a second machine segment in the industrial control system; (2) the one or more power components are configured to receive power directly from at least one of the second machine segment or an industrial control facility power source; (3) the safety controller is configured to receive safety event data from the one or more safety components or an adjacent machine segment in the industrial control system and, in response, initiate a safety response based on the safety event data; (4) the programmable logic controller is configured to control operation of the one or more motors via the one or more motor controllers both independent of the industrial control system and based on handling data received from the industrial control system; and (5) the programmable logic controller is configured to receive input/output data from the one or more input/output devices and transmit at least a portion of the input/output data to at least one of the second machine segment in the industrial control system or a gateway computing system for the industrial control system. In various embodiments, the programmable logic controller is configured to transmit first identifying data to the adjacent machine segment and receive second identifying data from the adjacent machine segment. In some embodiments, the programmable logic controller is further configured to control operation of the one or more motors based on the second identifying data.

### BRIEF DESCRIPTION OF THE DRAWINGS

In the course of this description, reference will be made to the accompanying drawings, which are not necessarily drawn to scale, and wherein:

FIG. 1 depicts a diagrammatic representation of a plurality machine segments that make up, for example, a material handling system or other industrial control system according to a particular embodiment;

FIG. 2 depicts an example and overview of a machine segment that may be utilized in the context of an industrial control system according to particular embodiments;

FIG. 3 is a schematic diagram of the machine segment shown in FIG. 2;

FIG. 4 is a schematic diagram of a plurality of machine segments that make up an industrial control system in the context of a particular industrial facility according to various embodiments;

FIG. 5 depicts an example of a computing environment that can be used for providing communication between a segment computing system in a particular machine segment with adjacent segment computing systems, gateway computing systems, and the like;

FIG. 6 is an example of a process performed for collecting, accessing, and providing data related to a particular machine segment;

FIG. 7 is an example of a process performed for receiving data from adjoining and/or adjacent machine segments;

FIG. 8 is an example of a process performed for identifying, by a particular machine segment, a gateway computing system within the industrial control system;

FIG. 9 is an example of a process performed for causing an emergency response to a triggering event;

FIG. 10 is an example of a process performed for configuring and adding a new machine segment to an industrial control system;

FIG. 11 is a block diagram illustrating an example system architecture that may be used in accordance with various aspects of the present disclosure; and

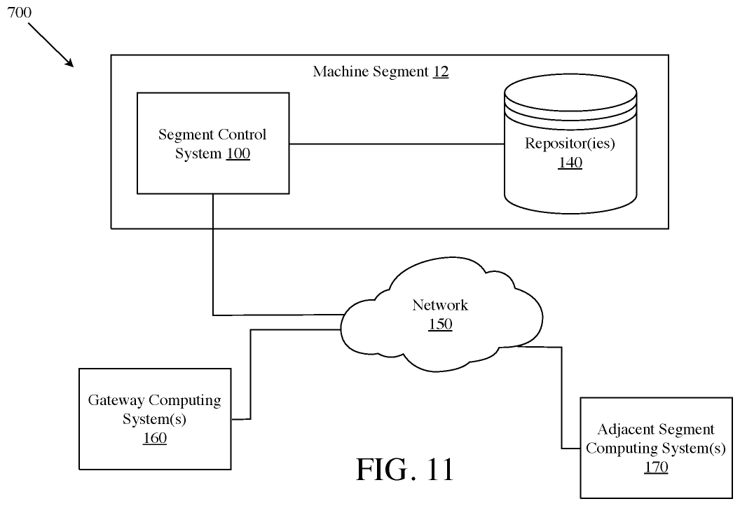

FIG. 12 is a schematic diagram of an example computing entity that may be used in accordance with various aspects of the present disclosure.

### DETAILED DESCRIPTION

Various aspects for practicing the technologies disclosed herein are described more fully hereinafter with reference to the accompanying drawings, in which some, but not all, aspects of the technologies disclosed are shown. Indeed, the aspects disclosed herein are provided so that this disclosure will satisfy applicable legal requirements and should not be construed as limiting or precluding other aspects applying the teachings and concepts disclosed herein. Like numbers in the drawings refer to like elements throughout.

### Overview

As previously noted above, conventional industrial control systems may include a configuration of machines that are typically designed with an architecture that includes a centralized motor control center (MCC) or other main control panel that controls the functioning of each of the machines found in the system. Such an architecture can prove technically challenging with respect to adding new machines to the system, making scalability a significant problem. In addition, the physical requirements make scalability a technical challenge in that each machine (e.g., motor thereof) requires conduit from the MCC. In such an arrangement, each field device (e.g., machine in the system) must be directly connected to the main control panel (e.g., requires a respective conduit run from the main control panel to the respective field device). As such, the addition or removal of field devices from the system requires new conduit runs and/or reconfiguring the entire system. In various aspects, reconfiguring the system may include reprogramming one or more of the field devices (e.g., including a new field device and/or existing field devices in the system).

An industrial control system 10 according to various embodiments described herein provides improved systems and methods for allowing modification of an existing industrial control system 10 and configuration of a new industrial control system 10 by utilizing individual modular machine segments 12 that are faster to configure within the context of an overall industrial control system 10, and less expensive to configure and maintain through all phases of each machine segment 12 lifecycle. This includes, for example, system design, engineering, installation, repair, segment replacement, and maintenance.

Various embodiments of an industrial control system 10 include architecture for a system that includes different machinery working within the system to achieve an overall process. For example, a conveyor system may be designed to include machinery used in processing parcels such as sorter machines, transport machines, gap optimizer machines, etc. Various aspects of industrial control systems described herein are directed to separating out each of the machines found in the system into a “segment” that is essentially operated independently of the other machines found in the system. Here, the industrial control system involves a control architecture in which each machine (e.g., segment) has its own power supply, Input/Output (I/O), emergency circuit, and controls/software (e.g., programmable logic controller (PLC)) that work independent of each other. In addition, the control architecture includes a gateway in which the different machines (segments) can communicate so that the machines can function within the system. In other aspects, the different machines (e.g., segments) can communicate directly (e.g., without a gateway computing system. In various aspects, the gateway is configured to interact with (e.g., communicate with via suitable network communications) one or more external computing systems. For example, a particular machine in the system can communicate with the gateway to inquire information on what to do with a particular parcel that the machine is receiving.

Each machine segment may include a respective PLC that operates on various control principals that include: (1) ‘know thyself’ in that the controller knows the function of the machine; (2) ‘know thy neighbors’ in that the controller knows the functions of the machine's immediate neighbors; and (3) ‘know thy data source’ in that the controller knows where the gateway is in the context of the overall industrial control system 10 so that the machine can provide and obtain needed information.

The controller (PLC) for each particular machine is configured, for example to: (1) store information related to the functionality of the particular machine; (2) receive information related to the functionality of adjacent machine segments (directly from the adjacent machine segments via a suitable direct connection, such as a network connection); and (3) identify a system gateway and receive, from the system gateway, needed information with respect to the particular segment's operation. As a result, various aspects of the control architecture described herein can allow for a machine (segment) to be added to the system with minimal effort (e.g., with only the need of an ethernet cable or other data cable for adding the segment to the network and a power cable). Accordingly, the novel control architecture can allow for easy scalability and modularity within production systems not found in conventional control architectures. In various aspects, a technician can simply connect a new segment to an adjacent segment's network input (e.g., to each adjacent segment's network input) and any suitable power source in order to connect to the network, receive/provide identifying information, identify the system gateway, etc.

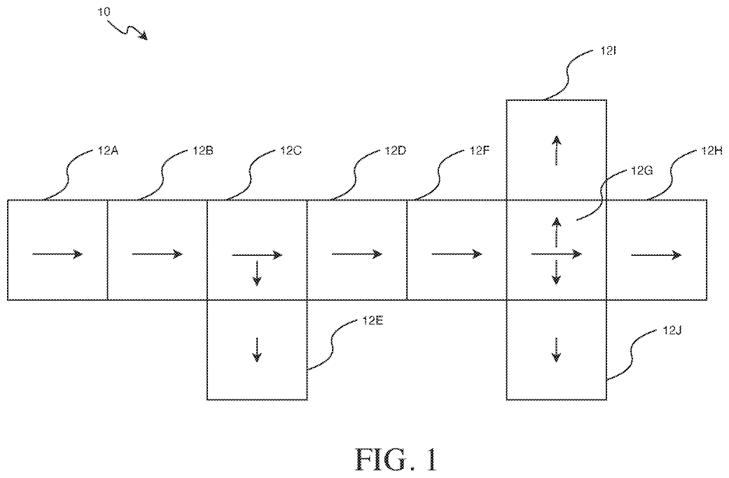

FIG. 1 depicts a diagrammatic representation of a plurality machine segments that make up an industrial control system 10 according to a particular example. In this example, the industrial control system will be described in the context of a material handling system. It should be understood in light of this disclosure that the principals discussed herein could be applied in any other industrial control system context. As may be understood from FIG. 1, an industrial control system 10 may include a plurality of machine segments 12A-J. Each of the plurality of machine segments 12A-I may provide a particular function within the context of the industrial control system 10. For example, any of the machine segments 12A-J may include any suitable transportation conveyor, merge section, sorter, load/unload conveyor, gap optimizer, scan tunnel, etc. In a particular example, a gap optimizer segment 12A may convey parcels or other material to a scan tunnel segment 12B, which in turn conveys the parcels or other material to a sorter segment 12C (and so on). In this way, each individual machine segment 12 may perform its individual function and then convey particular parcels or other materials to an adjacent segment.

As may be understood in the context of this disclosure, each individual machine segment 12A-J may be configured to provide functionality data to each adjacent machine segment (e.g., and receive functionality data from each adjacent machine segment) as well as identify the system gateway and provide functionality and configuration data to the gateway. In addition, each machine segment 12A-J may receive information from the gateway related to the respective machine segment's operation. Such an arrangement may, for example, enable the gateway to instruct operation of each individual segment, while enabling adjacent segments to communicate directly. In this way, modification of the system, or the addition/removal of individual segments can be implemented easily, without extensive rewiring or adding new conduit. For example, if adding a new segment between Segment 12A and 12B, the segment control system 100 for that segment can transmit its segment data to the gateway and the adjacent segments, so the gateway can insert the new segment in the proper place within the industrial control system 10, while Segment 12A can receive updated data about the segment that it is sending parcels to, while Segment 12B can receive updated data about the segment that it is now receiving parcels from. Each segment can then receive proper handling instructions from the immediately preceding segments (e.g., or the gateway).

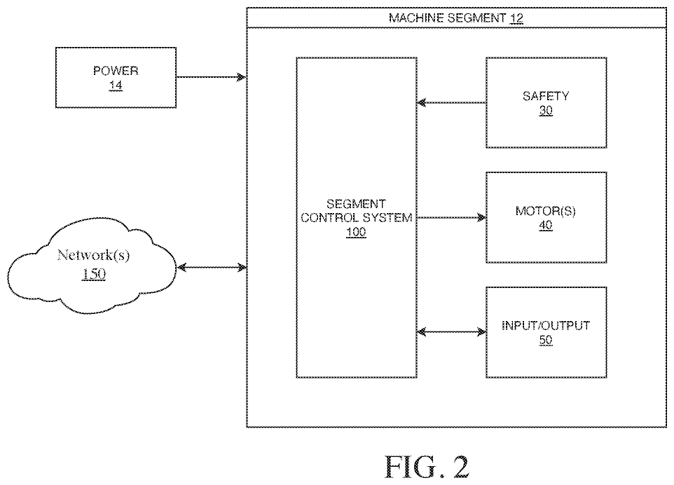

FIG. 2 depicts an example and overview of a machine segment that may be utilized in the context of an industrial control system according to particular embodiments. As may be understood from FIG. 2, each machine segment 12 includes a segment control system 100. As may be understood from FIG. 2, the segment control system 100 is operatively coupled to one or more safety components 30, which may, for example, provide information related to safety events or other triggering events that may require action by the segment control system 100 to address the safety event. As may be further understood from FIG. 2, the machine segment 12 includes one or more motors 40, the operation of which may be controlled by the segment control system 100. As may be understood by one skilled in the art, each machine segment 12 may include a plurality of motors that control operation of various machine segment 12 components (e.g., rollers, conveyors, etc.). In additional embodiments, the machine segment 12 includes one or more input/output devices 50 that are operatively coupled to the segment control system 100. In various embodiments, the one or more input/output devices 50 may include, for example, one or more sensors, one or more indicators (e.g., light indicators), imaging device(s), or any other suitable input/output device which may provide information to or receive information from the segment control system 100 for the machine segment 12.

As may further be understood from FIG. 2, each machine segment receives power 14 (e.g., from any suitable power source such as from an adjacent segment) and is in operative communication with one or more networks 150 (e.g., a local area network or other network). In various aspects, the one or more networks 150 include a data network over which the machine segment 12 can communicate with adjacent machine segments as well as a system gateway.

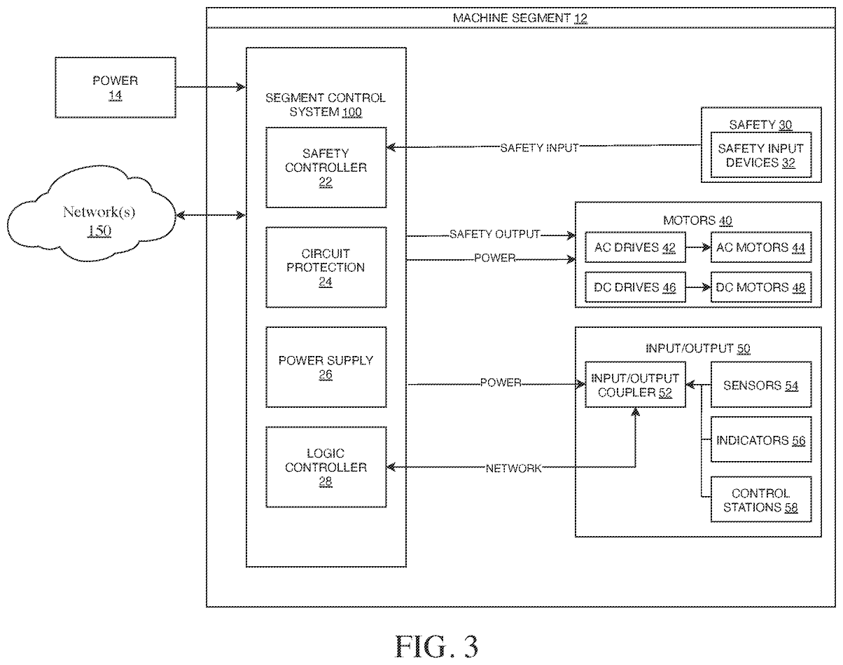

FIG. 3 is a schematic diagram of the machine segment shown in FIG. 2. As may be understood form FIG. 3, the machine segment 12 comprises a segment control system 100. In various embodiments, the segment control system 100 comprises a safety controller 22, one or more circuit protection components 24, one or more power supplies 26, and logic controller 28. These components are discussed more fully below.

In particular embodiments, the safety controller 22 is an independent controller configured to monitor (e.g., via one or more safety components 30) for particular triggering events and cause one or actions (e.g., such as an emergency stop of the machine segment 12, other adjacent machine segments, or an entire industrial control system 10 or any components thereof). In some aspects, the safety controller 22 is part of a distributed circuit in communication with a respective safety controller 22 of various adjoining machine segments 12. In some embodiments, the gateway (described more fully herein) is configured to monitor one or more defined e-stop groups for identification of triggering events in order to automatically trigger (e.g., at each machine segment in the group) an emergency stopping event (i.e., and whatever actions are programmed to occur in the event of an identified emergency). In particular embodiments, the safety controller 22 is in operative communication with the logic controller 28 of the machine segment 12. In such embodiments, the system is configured such that any communication loss between the safety controller 22 and the logic controller 28 results in an initiation of an emergency stopping response (e.g., by the safety controller 22 and/or the logic controller 28). In various embodiments, an independent safety controller 22 enables the creation and use of segmented, distributed emergency stopping circuits throughout the industrial control system 10 (without requiring a safety cable run back to a centralized controller as in traditional systems). In such a configuration, identification of emergency events and triggering of the appropriate response occurs independently of actions controlled by the logic controller 28. In this way, safety events can be monitored independently of the primary machine segment 12 functionality, providing redundancy, and enabling safer operation that isn't reliant on available processing capability of a particular machine segment's logic controller 28.

In particular embodiments, the inclusion of a safety controller 22 in each segment control system 100 of each machine segment 12 allows each machine segment 12 to operate as its own safety zone. In other embodiments, each machine segment 12 can be configured to be included in the safety zone of one or more neighboring segments. In still other embodiments, a user may define safety zones to include any particular machine segments 12A-Z in the system 10. The user may, for example, define safety zones at the gateway (e.g., using any suitable machine interface). Each segment having its own safety controller may, for example, makes the e-stop device loop local to the machine segment. In such embodiments, the signals used for the safety loop (e.g., and transmitted by the safety controller 22) are transmitted via a single cable, with machine segments branching off using splitters that have connectors but maintaining the integrity of the safety loop electrically back to the safety controller 22. In this way, any safety event can be transmitted within safety zone or to adjacent machine segments substantially instantaneously in order to affect an appropriate safety action (e.g., system and/or segment shutdown/motor operation secession, etc.). In other aspects, the safety event may be transmitted in a deterministic manner (e.g., in no more than a particular amount of time in response to identifying a safety event). For example, in some aspects, the system may broadcast safety event data within about fifty milliseconds, or sooner.

In various embodiments, the logic controller 28 is a programable logic controller, which may, for example, be configured to automate or otherwise control various electro-mechanical processes performed by the machine segment 12. In a particular embodiment, the logic controller 28 runs on a real time Linux kernel operating control logic through the CODESYS platform. In other aspects, the operating logic may be processed using IETC 61131 and/or Python or other suitable programming language/set of scripts. In particular aspects, the inclusion of a logic controller 28 in each segment control system 100 enables each machine segment 12 to remain operational independent of neighboring segments. As discussed above, the independent logic controller 28 in each machine segment 12 enables each segment to operate independent of any centralized motor control center or other centralized controller that conventional systems may have utilized.

In various aspects, each machine segment 12 is accessible via a human-machine interface. In various aspects, the human machine interface may provide configuration and commissioning tools for each segment. In a particular embodiment, the tools are programmed in an IEC 61131 language via the CODESYS platform (i.e., in particular aspects). In some aspects, the commissioning tools may only be accessible internally (e.g., on a private date network) and may enable a user to efficiently commission the new machine segment in the overall system. These tools may include system diagnostics, system analytics, default configuration templates, and device analytics. These tools may aid integrators in efficiently diagnosing issues and tailoring parameters and logic during initial segment setup and configuration. Parameters may include, for example, any configurable setting relevant to operation of the one or more machine segments (e.g., motor speeds). Other configuration tools may enable end-users to tailor parameters that will help them tailor the machine to their needs on a more day to day approach. This may include configuring parameters such as photo-eye timers, jam timers, safety zone reconfigurations, adding/removing devices (ex: start/stop button added, new sensor added, etc.), behavior of alarm logs, etc.

As mentioned above, the segment control system 100 further comprises one or more circuit protection components 24 and one or more power supplies 26. As may be understood by one skilled in the art, these components may, for example, manage power consumption by the segment control system 100 and power distribution to other system components (e.g., one or more safety components 30, one or more motors 40, one or more input/output devices 50, etc.).

As may be understood from FIG. 3, the segment control system 100 is operatively coupled to one or more safety components 30, which may, for example, provide information related to safety events or other triggering events that may require action by the segment control system 100 (e.g., the safety controller 22) to address the safety event. The one or more safety components 30 may, for example, include one or more safety input devices 32 (e.g., sensors, switches, etc.). As may be further understood from FIG. 3, the machine segment 12 includes one or more motors 40, the operation of which may be controlled by the segment control system 100 (e.g., any suitable component of the segment control system 100, such as the logic controller 28 and/or the safety controller 22). As may be understood by one skilled in the art, each machine segment 12 may include a plurality of motors that control operation of various machine segment 12 components (e.g., rollers, conveyors, etc.).

In the embodiment shown in FIG. 3, the one or more motors 40 comprise one or more AC drives 42, which may, for example, control operation of the one or more AC motors 44. In various embodiments, each AC motor has a respective AC drive. In some aspects, the one or more AC drives 42 may be used to control a speed of each of the one or more AC motors 44. The one or more motors 40 further comprise one or more DC drives 46, which may control operation of one or more DC motors 48. As may be understood by one skilled in the art, various components of a particular machine segment 12 may utilize AC or DC motors for different applications depending on the type of machine segment 12 and/or its operations. In various embodiments, the segment control system 100 (e.g., logic controller 28) may control the one or more motors 40 through operation of the one or more AC drives 42 and/or one or more DC drives 46 in order to drive each of the one or more AC motors 44 and/or one or more DC motors 48 at a desired speed. The segment control system 100 may also provide power to each of the one or more motors 40 (e.g., via the one or more power supplies 26).

In still other embodiments, the segment control system 100 comprises one or more input/output devices 50. As shown in FIG. 3, the one or more input/output devices 50 may include an input/output coupler 52. The input/output coupler 52 may further provide an input/output link between various sensors and the segment control system 100. In some aspects, the one or more input/output devices 50 further includes one or more sensors 54, one or more indicators 56, and one or more control stations 58. In various embodiments, the one or more sensors 54 may include any suitable sensors, such as an imaging device, machine-readable indicia reader (e.g., barcode scanner), etc. In particular embodiments, the one or more indicators 56 may include any suitable indicator such as a siren, light, etc. In various embodiments, the segment control system 100 receives data from the one or more sensors 54 and outputs data via the one or more input/output devices 50. In some embodiments, the segment control system 100 may receive user input via one or more control stations 58.

As may be further understood from FIG. 3, the segment control system 100 of the machine segment 12 may be communicatively connected to one or more networks 150. In some embodiments, the one or more networks 150 may include a private data network (e.g., a local network via which one or more machine segments communicate). In other embodiments, the one or more networks 150 may provide remote access to one or more system components (e.g., via a human-machine interface, etc.).

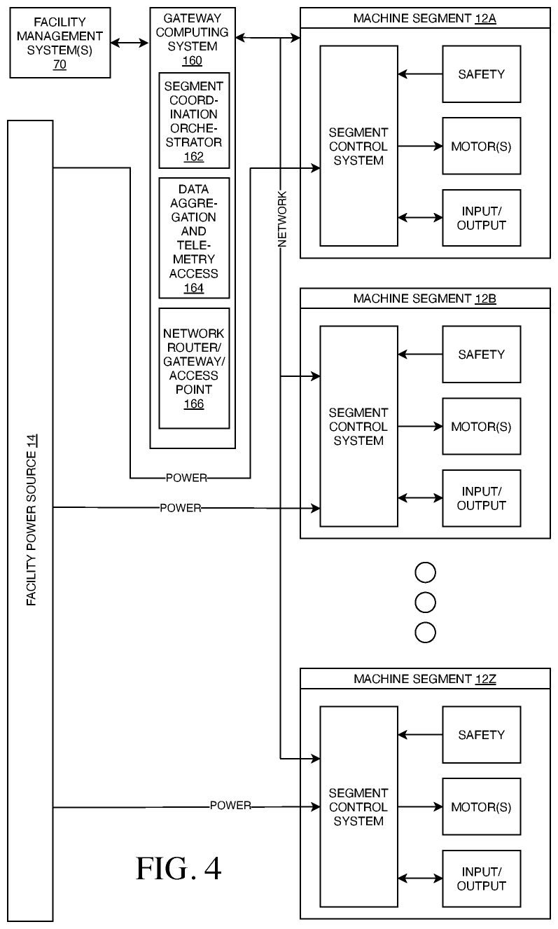

Turning to FIG. 4, a plurality of machine segments 12A-Z are shown. As may be understood from this figure, each of the machine segments 12A-Z may be communicatively connected via a network. Each segment may receive power from a suitable facility power source. The plurality of machine segments 12A-Z may be further be in network communication with a gateway computing system 160 and/or facility management system 70. The gateway computing system 160 and/or facility management system 70 may provide remote access to various machine segments, as well as remote access to any suitable human-machine interface. In some aspects, the gateway computing system 160 comprises at least a segment coordination orchestrator 162 (e.g., segment coordination orchestration system); a data aggregation and telemetry access system 164, and a network router/gateway/access point 166. In some aspects, the operations described herein as conducted by the gateway computing system 160 may be conducted by any suitable component or combination of components thereof.

As may be understood in light of this disclosure, as new machine segments are added to the system, the new segment may automatically provide and receive data to/from neighboring segments as well as the gateway computing system 160. In particular embodiments, a particular machine segment (e.g., machine segment 12A) may serve as the gateway computing system 160. In still other aspects, the system may automatically modify a human-machine interface to insert the new segment in its proper location within the industrial control 10. In this way, a user may access the industrial control system 10 and individual machine segments by selecting an indicia on the human-machine interface that corresponds to the desired segment. FIG. 1 depicts an example of what a user may see when accessing a human-machine interface. The user may then select individual segments to view data related to that segment. In this way, the human-machine interface may provide a centralized dashboard via which the user can monitor the industrial control system 10, including usage data for each component, current operation, etc.

### Example Computing Environment

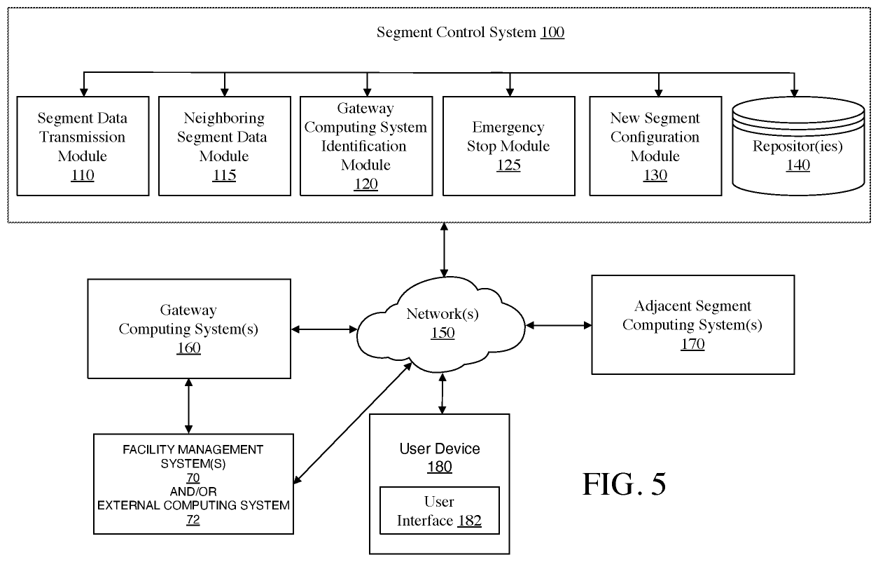

FIG. 5 depicts an example of a computing environment that can be used for providing communication between a segment computing system in a particular machine segment with adjacent segment computing systems, gateway computing systems, and the like. For example, the computing environment can be used to receive data related to functionality of neighboring machine segments for a particular segment, store and access data related to functionality of the machine segment itself (and provide that data to other machine segments as necessary), track lifecycle data for various machine segment components, generate and modify a human-machine interface for the segment control system 100, and/or identify a gateway computing system 160 that may receive data and/or control operation of a complete industrial control system 10.

In various aspects, a segment control system 100 is provided within the computing environment that includes software components and/or hardware components to communicate with adjacent machine segments, a gateway computing system 160, etc. In various aspects, the segment control system 100 may communicate with the gateway computing system 160 and adjacent segment computing system 170 via one or more networks 150 (e.g., a direct network cable connection between the segment control system and each adjacent segment computing system 170). In this way, the direct network cable connection between the segment control system 100 and each adjacent segment computing system 170 may chain together each of the machine segments 12 in the industrial control system 10, providing chained network communication across the system. In still other embodiments, a user device 180 may access any one of the segment control system 100, gateway computing system 160 and/or adjacent segment computing system 170. The user device 180 may include a user interface 182 via which the user device 180 can access a human machine interface to access data related to the segment control system 100, and or provide system input.

In some instances, the segment control system 100 may include one or more repositories 140 that can be used for storing data related to the machine segment 12 or other data. This may include, for example, identifying data for the machine segment 12, data received form adjacent machine segments, metadata regarding system operation of item handling, etc.

In various aspects, the segment control system 100 may communicate with a facility management system 70 and/or third party computing system 72 (e.g., directly over a network 150 or via a gateway computing system 160).

In some aspects, the segment control system 100 executes a segment data transmission module 110 to collect, access, and provide data related to a particular machine segment 12. For example, the segment data transmission module 110 may provide data related to the functionality of the machine segment 12 to adjacent segment computing system 170 (e.g., data related to what function the segment performs, other adjacent segments, etc.). In still other aspects, the segment data transmission module 110 may collect life cycle data for one or more machine segment components. The segment data transmission module 110 may further provide data to a gateway identified in the context of the gateway computing system identification module 120 discussed more fully below.

In additional or alternative aspects, the segment control system 100 executes a neighboring segment data module 115. The neighboring segment data module 115 may, for example, enable a machine segment to receive data from neighboring segments related to functionality, gateway ID, etc. In additional or alternative aspects, the segment control system 100 executes a gateway computing system identification module 120. The gateway computing system identification module 120 may enable a machine segment to identify a gateway computing system 160, and receive instructions or information form the identified gateway computing system 160. In additional or alternative aspects, the segment control system 100 executes an emergency stop module 125. In various aspects, the emergency stop module 125 provides emergency stopping functionality within an e-stop circuit. In other aspects, the segment control system 100 executes a new segment configuration module 130. In particular aspects, the new segment configuration module 130 provides configuration of a new segment for addition to an industrial control system 10. Further detail is provided below regarding the configuration and functionality of the 110, neighboring segment data module 115, gateway computing system identification module 120, emergency stop module 125, and new segment configuration module 130 according to various aspects of the disclosure.

### Segment Data Transmission Module

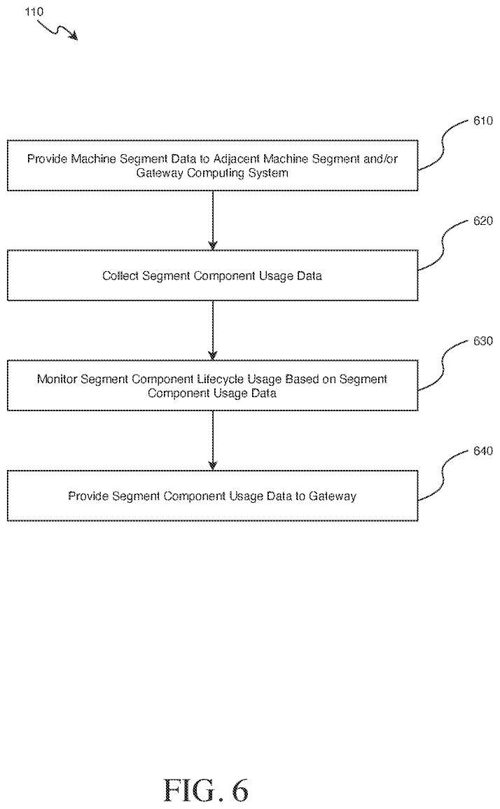

Turning now to FIG. 6, additional details are provided regarding a segment data transmission module 110 which may be used to provide data related to the functionality of the machine segment 12 to an adjacent segment computing system 170 (e.g., data related to what function the segment performs, other adjacent segments, etc.) in accordance with various aspects. Accordingly, the flow diagram shown in FIG. 6 may correspond to operations executed, for example, by computing hardware found in the segment control system 100 as described herein, as the computing hardware executes the 110.

The process involves the segment data transmission module 110 providing machine segment data to adjacent machine segment(s) and/or the gateway computing system at operation 610. Identification of a gateway computing system is discussed more fully below with respect to the gateway computing system identification module 120. In various embodiments, each machine segment is configured to communicate to other segments over one or more networks 150. In various aspects, the information communicated may include information related to functions and parameters about the machine segment itself. In various aspects, this may include, for example, main segment function, number of charge/discharge points in the segment, speed of conveyance, safety zone information, available communication protocols, version numbers and any other relevant piece of information a neighboring segment might require. In particular aspects, each segment stores this information locally and transmits the information to neighboring segments. In some aspects, the segment control system 100 transmits this information over the one or more networks 150 in response to a request form a neighboring segment. In other aspects, the segment control system 100 transmits this information over the one or more networks 150 automatically (e.g., in response to the machine segment being added to the network, in response to a replacement of an adjacent segment or the introduction of a new adjacent segment, etc.). In particular aspects, each machine segment 12 (e.g., via its respective segment control system 100) is configured to transmit such information to each neighboring machine segment. For example, referring back to FIG. 1, Segment 12B may be configured to transmit such information to both Segment 12A and Segment 12C (e.g., upon connection to each respective segment, in response to a configuration request for the segment 12B, etc.).

Continuing to operation 620, the segment control system 100 may collect segment component usage data. The segment control system 100 may be configured to monitor component usage (e.g., motors, etc.) including power consumption, motor speed, runtime, lifecycle data, etc. The segment control system may store such data in a suitable data repository.

Next, at operation 630, the segment control system 100 may monitor segment component lifecycle usage based on segment component usage data. For example, the segment control system 100 may be configured to monitor component usage against a repair/replacement schedule in order to determine when particular components and/or machine segments need to be repaired, services, and/or replaced. At operation 640, the segment control system 100 may then provide the segment component usage data to the gateway computing system 160. By providing the segment component usage data to the gateway computing system 160, the system may enable an individual to monitor life cycle usage of individual segment components (as well as overall segment usage) to ascertain and follow repair/replacement schedules for various system components and/or segments. The user may monitor such information via a suitable human-machine interface generated by the system. The human-machine interface may, for example, provide a centralized user interface for accessing machine segment data in a single interface. Such a configuration may enable a user to access individual segment data for the complete industrial control system 10 without having to access each segment individual (e.g., via a local control system).

### Neighboring Segment Data Module

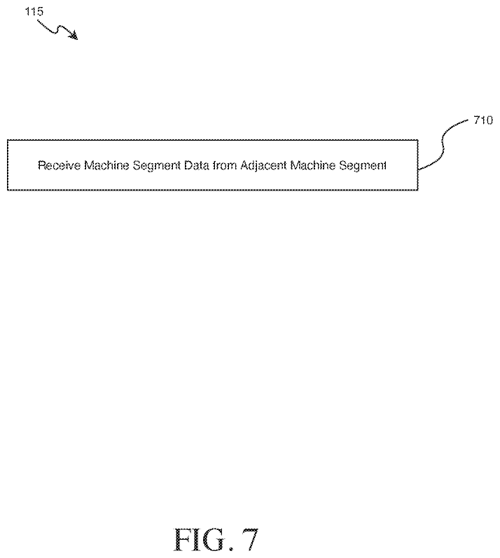

Turning now to FIG. 7, additional details are provided regarding a neighboring segment data module 115 which may be used to receive data related to adjacent segment computing system 170 at a particular machine segment 12 (i.e., a segment control system 100) in accordance with various aspects. Accordingly, the flow diagram shown in FIG. 7 may correspond to operations executed, for example, by computing hardware found in the segment control system 100 as described herein, as the computing hardware executes the neighboring segment data module 115. In still other aspects, the operations may be executed by any other system component and/or computing hardware described herein (e.g., the adjacent segment computing system 170, the gateway computing system 160, etc.).

When executing the neighboring segment data module 115, the segment control system 100, at operation 710, may receive machine segment data from each adjacent machine segment. For example, as shown in FIG. 1, each of Machine Segment 12B, 12E, and 12D may be adjacent to machine segment 12C. As will be understood by one skilled in the art, ‘adjacent’ machine segments may include those that are in physical communication with one another (e.g., have a relationship in the context of the industrial control system 10 such that the respective adjacent segments pass items to or receive items from an adjacent segment). In other aspects, ‘adjacent’ machine segments may include machine segments for which there exists a direct, network connection (e.g., cable connection). The information may include, for example, main segment function, number of charge/discharge points in the segment, speed of conveyance, safety zone information, available communication protocols, version numbers and any other relevant piece of information a machine segment may require from a neighboring segment. In some aspects, the segment control system 100 may receive adjacent machine segment data from the gateway computing system 160. In various embodiments, by knowing the function of adjoining machine segments, a particular machine segment may configure itself such that it coordinates with the adjoining segment. For example, if a first segment receives parcels from a second segment, the second segment may receive operational information from the first segment (e.g., belt speed), so the second segment can match or otherwise coordinate the belt speed. In other aspects, the receiving machine segment can receive information from a prior segment (or the gateway) regarding how to handle a particular parcel or other item. In particular aspects, each machine segment 12 stores segment type data such that the machine segment 12 can identify an adjacent segment based on a segment ID received from the adjacent segment.

### Gateway Computing System Identification Module

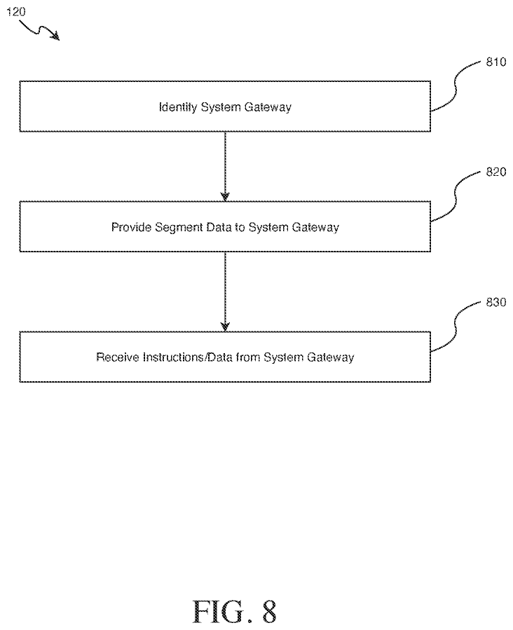

Turning now to FIG. 8, additional details are provided regarding a gateway computing system identification module 120 which may be used to identify a gateway computing system within the industrial control system 10 in accordance with various aspects. Accordingly, the flow diagram shown in FIG. 8 may correspond to operations executed, for example, by computing hardware found in the segment control system 100 as described herein, as the computing hardware executes the gateway computing system identification module 120. As discussed above, the gateway computing system 160 may include at least a segment coordination orchestrator 162 (e.g., segment coordination orchestration system); a data aggregation and telemetry access system 164, and a network router/gateway/access point 166. In other aspects, the gateway computing system 160 as described herein may include or omit various components described herein. For example, in some aspects the gateway computing system 160 may perform functions performed by any subcomponent thereof. In other aspects, the gateway computing system 160 may not perform particular functionality described herein. For example in some aspects, coordination among segments may be performed in a peer-to-peer fashion (e.g., directly between machine segments 12). In other aspects, data aggregation may occur outside of a segment, negating the need for data aggregation functionality at the gateway computing system 160. Still other aspects of the gateway computing system 160 may omit certain functions or perform certain functions in addition to those described herein.

At operation 810, the segment control system 100 may identify the system gateway. Generally speaking, the control architecture includes a gateway in which the different machines (segments) can communicate so that the machines can function within the system. For example, a particular machine in the system can communicate with the gateway to inquire information on what to do with a particular parcel that the machine is receiving. In order to do so, however, each machine segment 12 must identify the gateway within the system. In some embodiments, a particular machine segment may serve as the gateway for the system. In still other embodiments, the industrial control system 10 may include a stand-alone gateway computing system 160 (e.g., see FIG. 4).

In various embodiments, the gateway comprises a Linux-based programmable logic controller that can help machine segments learn what neighbors are present on the machine network. As such, when adding a new machine segment, it is necessary for the segment to identify the gateway and inform the gateway of its addition. In this way, the system can incorporate a new segment simply by physically installing it, running power to the new segment control system 100 and allowing the gateway to inform the network of the addition of a segment. The gateway may then store data related to each machine segment in the system, as well as each segments position within the system.

In some embodiments, a machine segment may receive identifying data for the gateway computing system from one of its adjacent machine segments (e.g., when receiving segment data from its neighbors). In this way, the system may enable a plug-and-play configuration of new segments, such that the configuration of the new segment simply requires plugging the new segment into its spot in the industrial control system 10 such that it receives sufficient data from the adjacent machine segment to identify its place within the context of the system, while providing sufficient data to the gateway computing system (e.g., or one or more adjacent segment control systems) to enable the adjacent systems and overall systems to incorporate the new segment.

At Operation 820, the segment control system 100 provides segment data to the system gateway. In some aspects, the segment control system 100 may provide any suitable information to the gateway described herein (e.g., information that the segment control system 100 provides to adjoining segments).

At operation 830, the segment control system 100 receives instructions and/or data from the system gateway. In various aspects, the data may include product data (e.g., an ID of an item that the machine segment is receiving). In some aspects, the gateway stores metadata regarding information the gateway has received from each segment. The gateway can then provide information about particular items to a particular machine segment that the gateway has received from other segments (e.g., where the package was last seen, first seen, its destination, all the timestamps related to package events, etc.).

In various aspects, the gateway is configured to maintain a full, up-to-date representation of the industrial control system 10, including all machine segments and their locations within the industrial control system 10.

### Emergency Stop Module

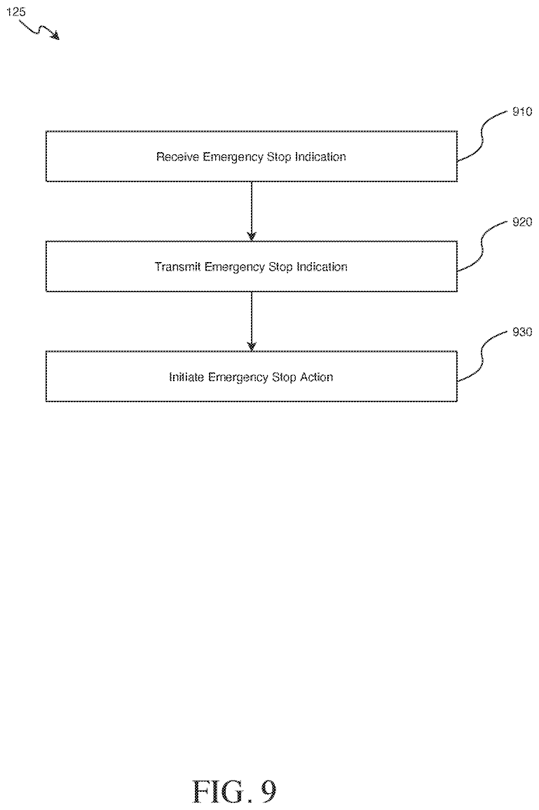

Turning now to FIG. 9, additional details are provided regarding an emergency stop module 125 which may be used to invoke an emergency response at one or more machine segments in accordance with various aspects. Accordingly, the flow diagram shown in FIG. 9 may correspond to operations executed, for example, by computing hardware found in the segment control system 100 (e.g., the safety controller 22) as described herein, as the computing hardware executes the emergency stop module 125.

At operation 910, the segment control system 100 (e.g., the safety controller 22) may receive an emergency stop indication. The safety controller 22 may receive the indication from a different segment (e.g., machine segment 12A may receive the indication from adjacent machine segment 12B), from the gateway computing system 160, or from the one or more safety input devices 32 (e.g., sensors, etc.). Continuing to operation 920, the segment control system 100 (e.g., the safety controller 22) may transmit an emergency stop indication to one or more other machine segments and/or the gateway computing system 160. In various aspects, operation 920 may occur after and/or in conjunction with operation 930 described below. In some aspects, the segment control system 100, at operation 920, transmits the active emergency state of operation n930 described below. As discussed herein, each machine segment may form part of an emergency stop circuit through independent safety controllers on every segment. The system may utilize a single cable for a safety loop, with devices branching off of the cable using splitters that maintain the integrity of the safety loop electrically back to each safety controller 22. In this way, in response to a safety event, each machine segment may transmit, via the safety controller 22, safety even information to each additional segment in the safety circuit. In some aspects, the gateway computing system 160 may define different safety groups among the various machine segments.

In still other aspects, the system may utilize a single loop (e.g., a dual-channel loop having two parallel circuits forming a single loop). In particular aspects, the single loop is embodied in a cable (e.g., the loop extends out and back in a single cable). In particular embodiments, the system utilizes a single loop per input in the safety controller 22 (e.g., as a respective safety input device 32). In various aspects, each loop may encapsulate one or more devices, with additional devices tapping into the loop via additional respective cable connections (e.g., via one or more cable splitters that maintain the integrity of the individual loop. In some aspects, by providing a plurality of safety controllers 22 across the system (e.g., for each machine segment 12), the system includes/defines a plurality of safety loops. In particular embodiments, each loop may be local to the particular segment 12 (e.g., and/or segments 12A-Z) that the safety loop serves. In various aspects, each loop is associated with a different safety zone (e.g., which may be defined during configuration of one or more machine segments 12A-Z). In particular aspects, by providing more safety loops that are localized to particular machine segments 12, the system may provide advantages over conventional industrial control systems. For example, in a conventional system having a centralized motor control center, the system generally includes a system-wide loop that encapsulates all segments, with the loop (e.g., or each individual loop in the case of multiple loops) requiring a separate run back to the motor control center. Other conventional motor control centers require each safety actuator to be hardwired directly bac to the motor control center. This creates a need for a vast number of cable runs over long distances across the entire industrial plant or other location. The localized loops described herein, in various aspects, eliminate the need to complicated and expensive cable runs to each device.

At operation 930, the segment control system 100 may initiate an emergency stop action. In various embodiments, the segment control system 100 (e.g., the safety controller 22 and/or the logic controller 28) cause the one or more motors 40 to stop operation in response to an emergency stop indication. In other aspects, the safety controller 22 may take any other suitable action in response to an emergency stop indication.

In particular embodiments, the safety controller 22 is an independent controller configured to monitor (e.g., via one or more safety components 30) for particular triggering events and cause one or actions (e.g., such as an emergency stop of the machine segment 12, other adjacent machine segments, or an entire industrial control system 10 or any components thereof). In some aspects, the safety controller 22 is part of a distributed circuit in communication with a respective safety controller 22 of various adjoining machine segments 12. In some embodiments, the gateway (described more fully herein) is configured to monitor one or more defined e-stop groups for identification of triggering events in order to automatically trigger (e.g., at each machine segment in the group) an emergency stopping event (i.e., and whatever actions are programmed to occur in the event of an identified emergency). In particular embodiments, the safety controller 22 is in operative communication with the logic controller 28 of the machine segment 12. In such embodiments, the system is configured such that any communication loss between the safety controller 22 and the logic controller 28 results in an initiation of an emergency stopping response (e.g., by the safety controller 22 and/or the logic controller 28). In various embodiments, an independent safety controller 22 enables the creation and use of segmented, distributed emergency stopping circuits throughout the industrial control system 10 (without requiring a safety cable run back to a centralized controller as in traditional systems). In such a configuration, identification of emergency events and triggering of the appropriate response occurs independently of actions controlled by the logic controller 28. In this way, safety events can be monitored independently of the primary machine segment 12 functionality, providing redundancy, and enabling safer operation that isn't reliant on available processing capability of a particular machine segment's logic controller 28.

In particular embodiments, the inclusion of a safety controller 22 in each segment control system 100 of each machine segment 12 allows each machine segment 12 to operate as its own safety zone. In other embodiments, each machine segment 12 can be configured to be included in the safety zone of one or more neighboring segments. In still other embodiments, a user may define safety zones to include any particular machine segments 12A-Z in the system 10. The user may, for example, define safety zones at the gateway (e.g., using any suitable machine interface). Each segment having its own safety controller may, for example, makes the e-stop device loop local to the machine segment. In such embodiments, the signals used for the safety loop (e.g., and transmitted by the safety controller 22) are transmitted via a single cable, with machine segments branching off using splitters that have connectors but maintaining the integrity of the safety loop electrically back to the safety controller 22. In this way, any safety event can be transmitted within safety zone or to adjacent machine segments substantially instantaneously in order to affect an appropriate safety action (e.g., system and/or segment shutdown).

### New Segment Configuration Module

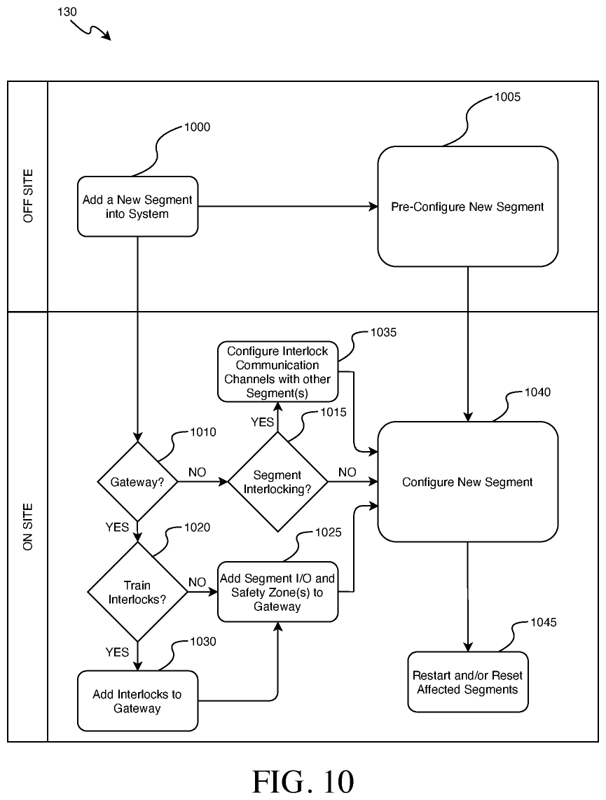

Turning now to FIG. 10, additional details are provided regarding a new segment configuration module 130 which may be used to configure a new segment for addition to an industrial control system 10 in accordance with various aspects. Accordingly, the flow diagram shown in FIG. 10 may correspond to operations executed, for example, by computing hardware found in the segment control system 100 as described herein, as the computing hardware executes the new segment configuration module 130.

At Operation 1000, the segment control system 100 adds a new segment into the industrial control system 10. In various aspects, the new segment configuration module 130 may be executed in the context of adding a new machine segment 12 to an existing industrial control system 10. In other aspects, the segment control system 100 may execute the new machine segment configuration module 130 in the context of configuration a new (e.g., newly installed) industrial control system 10, for example, during initial setup of the new industrial control system 10. For example, the segment control system 100 may receive a request (e.g., from a user device 180) to add a new segment (e.g., sorter machine, transport machine, gap optimizer machine, etc.) to the industrial control system 10 (e.g., either an existing industrial control system or an industrial control system that is being newly configured). For example, in the exemplary industrial control system shown in FIG. 1, a user may desire to add an additional segment between machine segment 12F and machine segment 12G. The additional machine segment may provide any suitable functionality to the industrial control system 10. When adding the new machine segment to the industrial control system 10, the segment control system 100 may be configured to configure the new segment according to its own functionality in addition to the new segment's context within the overall industrial control system 10.

For example, at least some configuration steps may occur ‘off site’ (e.g., prior to connecting the new segment to one or more adjacent machine segments), while other configuration steps may occur ‘on-site’ (e.g., after connecting the new segment to one or more adjacent machine segments). In some aspects, one or more of the configuration steps related to adding a new segment 12 to an existing industrial control system 10 may occur substantially automatically (e.g., through execution of one or more system modules described herein, or through performing functions described herein with respect to one or more system modules).

When configuring a new machine segment 12, the system may, at Operation 1005, pre-configure the new segment prior to integrating the new segment 12 with the industrial control system. For example, when pre-configuring the new segment 12, the segment control system 100 (e.g., and/or computing hardware associated with the machine segment 12 itself) may receive configuration data for the particular segment being added. For example, the segment control system 100 may receive controller configuration data for each of one or more controllers that make up part of the machine segment 12 (e.g., the logic controller 28, the safety controller 22, one or more motor controllers such as AC and/or DC drives 42, 48, etc.). Configuring the controllers and segment may include, for example, setting up firmware, software licenses, runtime, etc. In various aspects, the segment control system 100 may load a segment program template for the segment (e.g., based on the segment type). In some aspects, the segment control system 100 may receive and configure input output signals for the particular segment based on a number of devices in the industrial control system 10, particularly devices adjacent the new segment being added to the system 10. The segment control system 100 may then populate an input/output map program for the new segment that defines data that will be received from and transmitted to adjacent machine segments. In this way, the system may pre-configure the new segment 12 to identify particular signal data from adjacent segments and provide appropriate data to those adjacent machine segments.

In still other aspects, pre-configuring a particular new segment may include selection of application function blocks for the particular segment. In various embodiments, the segment control system 100 may receive selection of particular function blocks (i.e., software application configured to execute on segment startup) for execution by the new segment. These function blocks may include, for example, sorting, merging, tracking, or other suitable functions—these functions may be defined by the particular type of segment being added to the industrial control system 10.

In particular embodiments, the segment control system 100 may be configured to receive application settings and behavior data for the new segment (e.g., during particular shifts). These setting may include, for example, speed, direction, segment function, and the like. For example, a particular segments orientation within the industrial control system 10 may determine a direction (e.g., of one or more rollers configured to move parcels across the segment via conveyor). In still other embodiments, the segment control system 100 may receive and/or assign zone data for the new segment. The zone data may include, for example, zone assignments related to one or more adjacent machine segments. The zone data may provide interlock data for the new machine segment, which may, for example, control operation of one or more segment components following incorporation into the industrial control system. For example, the system may assign the new segment as part of a zone with an adjacent segment, such that the operation of conveyors or other components are coordinated (e.g., operate at substantially the same speed, or at coordinated speeds to provide required functionality in the context of the overall system). In still other embodiments, pre-configuration may involve establishing the new segment in a human-machine interface for the industrial control system 10 (e.g., as discussed herein).

When adding a new segment to the system (e.g., at Operation 1000), the process may involve, following pre-configuration, integration of the machine segment within the industrial control system 10 at the site of the industrial control system. For example, as discussed herein, in various aspects, a technician can simply connect a new segment to an adjacent segment's network input and any suitable power source in order to connect to the network, receive/provide identifying information, identify the system gateway, etc. as part of the new segment configuration process. The system may, for example, at Operation 1010, determine whether the system is using a gateway computing system 160 (e.g., to control operation of one or more system components/segments). In various aspects, the industrial control system 10 may utilize a gateway computing system 160 when the system includes at least a particular number of segments (e.g., at least four segments, at least five segments, at least ten segments, or any other suitable number of segments that may benefit from centralized control via a gateway computing system 160).

Generally speaking, the control architecture includes a gateway in which the different machines (segments) can communicate so that the machines can function within the system. For example, a particular machine in the system can communicate with the gateway to inquire information on what to do with a particular parcel that the machine is receiving. In order to do so, however, each machine segment 12 must identify the gateway within the system. In some embodiments, a particular machine segment may serve as the gateway for the system. In still other embodiments, the industrial control system 10 may include a stand-alone gateway computing system 160 (e.g., see FIG. 4).

In some embodiments, a machine segment (e.g., upon connection to one or more adjacent segments in the industrial control system 10) may receive identifying data for the gateway computing system 160 from one of its adjacent machine segments (e.g., when receiving segment data from its neighbors).

In response to determining that the system is using a gateway at operation 1010 (e.g., in addition to identifying the gateway itself), the system may be configured to identify whether that are any train interlocks for the new segment at Operation 1020. Train interlocks may include, for example, a group of segments that start and stop together (e.g., a set of conveyors). The segment control system 100 may receive train interlock data from an adjacent segment and/or the identified gateway computing system. In other aspects, the system may identify train interlocks based on the pre-configuration data and/or process.

Continuing to Operation 1030, in response to determining that there are train interlocks, the system may provide the interlock data to the system gateway. In this way, the gateway computing system 160 may receive train interlock data for newly added segments in order to control operation and provide operating parameters to each new segment during operation (i.e., commands to start/stop with the train interlock that has been assigned). In some aspects, the system may be configured to add the interlocks to the gateway by transmitting the new segment data to the identified gateway (e.g., as discussed above in the context of the segment data transmission module 110).

After adding the interlocks to the gateway (e.g., or determining that there are not any train interlocks), the process may involve adding segment input/output and safety zone data to the gateway at Operation 1025. This may include, for example, providing input/output data (e.g., identified during pre-configuration) to the gateway. In some aspects, adding the safety zone data for the new segment to the gateway involves performing operations described above in the context of the emergency stop module 125.

In some aspects, in response to determining that the system does not use a gateway at Operation 1010, the system determines whether the new segment interlocks with (e.g., sends and/or receives data to/from adjacent segments or otherwise communicates with them) at Operation 1015. If so, the system, at Operation 1035, configures interlock communication channels with other segments (e.g., adjacent segments). This may include, for example, operations implemented in the context of the neighboring segment data module 115 discussed above.

At operation 1040, following configuration of interlock communication channels (if necessary) and segment input/output communications and safety zones, the system configures the new segment (e.g., in the context of the overall industrial control system 10). For example, the system is configured to confirm configuration of a local safety module that the new segment is part of. In other aspects, the system is configured to confirm one or more connected fieldbus devices and or I/O connections (e.g., IO-link). The system may, for example, confirm the availability of communication channels and input/output signals to and from the new segment (e.g., and any neighboring/adjacent segments). The system may further configure the new segment by confirming variable frequency drive control (e.g., as required for the new segment) of one or more drive motors in the new segment. At Operation 1045, the system may then restart and/or reset any affected segments (e.g., the new segment, neighboring segments, etc.).

### Example Technical Platforms

Aspects of the present disclosure may be implemented in various ways, including as computer program products that comprise articles of manufacture. Such computer program products may include one or more software components including, for example, software objects, methods, data structures, and/or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query, or search language, and/or a report writing language. In one or more example aspects, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

According to various aspects, a non-volatile computer-readable storage medium may include a floppy disk, flexible disk, hard disk, solid-state storage (SSS) (e.g., a solid-state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

According to various aspects, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where various aspects are described to use a computer-readable storage medium, other types of computer-readable storage media may be substituted for or used in addition to the computer-readable storage media described above.

Various aspects of the present disclosure may also be implemented as methods, apparatuses, systems, computing devices, computing entities, and/or the like. As such, various aspects of the present disclosure may take the form of a data structure, apparatuses, system, computing device, computing entity, and/or the like executing instructions stored on a computer-readable storage medium to perform certain steps or operations. Thus, various aspects of the present disclosure also may take the form of entirely hardware, an entirely computer program product, and/or a combination of computer program products and hardware performing certain steps or operations.

Various aspects of the present disclosure are described below with reference to block diagrams and flowchart illustrations. Thus, each block of the block diagrams and flowchart illustrations may be implemented in the form of a computer program product, an entirely hardware aspect, a combination of hardware and computer program products, and/or apparatuses, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. According to some aspects, retrieval, loading, and/or execution may be performed in parallel such that multiple instructions are retrieved, loaded, and/or executed together. Thus, such aspects can produce specially configured machines performing the steps or operations specified in the block diagrams and flowchart illustrations. Accordingly, the block diagrams and flowchart illustrations support various combinations of aspects for performing the specified instructions, operations, or steps.

### Example System Architecture

FIG. industrial control system 10 is a block diagram of an example of a system architecture 700 that can be used for can be used for providing communication between a segment computing system in a particular machine segment with adjacent segment computing systems, gateway computing systems, and the like. As may be understood from FIG. 10, the system architecture 700 in some aspects may include a machine segment 12 with a segment control system 100 that is coupled to a data repository power one or more data repositories 140. The data repository power one or more data repositories 140 may be made up of computing components such as servers, routers, data storage, networks, and/or the like that are used by the segment control system 100 to store and manage data related to machine segment functionality and gateway identification.

According to various aspects, any suitable system aspect may execute a 110, neighboring segment data module 115, gateway computing system identification module 120, and/or emergency stop module 125 as described herein. Further, according to particular aspects, the 1010 may provide one or more graphical user interfaces (e.g., one or more webpages, webform, and/or the like through the website) through which a user device 180 can access system information (e.g., a machine-human interface representative of one or more system aspects such as machine segments, through which a user can access data related to and provide input to various segments).

### Example Computing Hardware

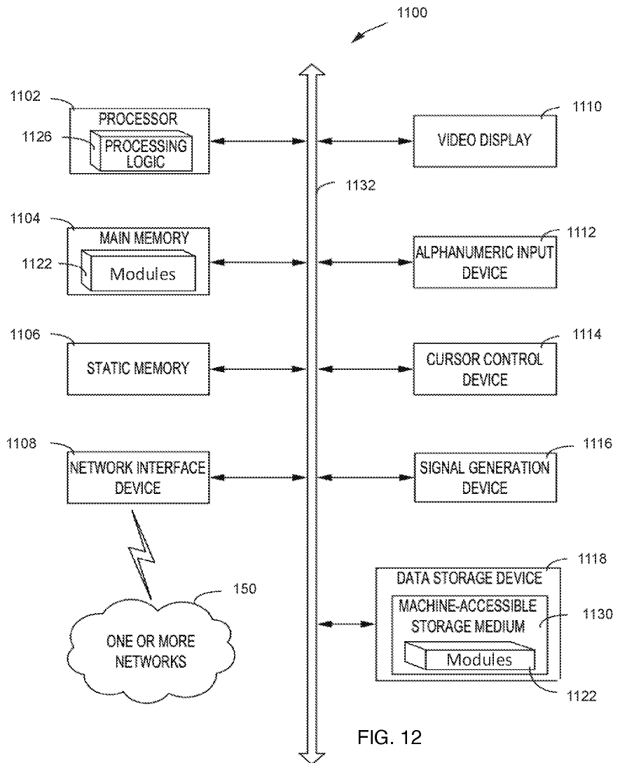

FIG. 12 illustrates a diagrammatic representation of a computing hardware device 1100 that may be used in accordance with various aspects. For example, the hardware device 1100 may be computing hardware such as a segment control system 100 as described throughout. According to particular aspects, the hardware device 1100 may be connected (e.g., networked) to one or more other computing entities, storage devices, and/or the like via one or more networks one or more networks 150 such as, for example, a LAN, an intranet, an extranet, and/or the Internet. As noted above, the hardware device 1100 may operate in the capacity of a server and/or a client device in a client-server network environment, or as a peer computing device in a peer-to-peer (or distributed) network environment. In some aspects, the hardware device 1100 may be a personal computer (PC), a tablet PC, a set-top box (STB), a Personal Digital Assistant (PDA), a mobile device (smartphone), a web appliance, a server, a network router, a switch or bridge, or any other device capable of executing a set of instructions (sequential or otherwise) that specify actions to be taken by that device. Further, while only a single hardware device 1100 is illustrated, the term “hardware device,” “computing hardware,” and/or the like shall also be taken to include any collection of computing entities that individually or jointly execute a set (or multiple sets) of instructions to perform any one or more of the methodologies discussed herein.

A hardware device 1100 includes a processor 1102, a main memory 1104 (e.g., read-only memory (ROM), flash memory, dynamic random-access memory (DRAM) such as synchronous DRAM (SDRAM), Rambus DRAM (RDRAM), and/or the like), a static memory 1106 (e.g., flash memory, static random-access memory (SRAM), and/or the like), and a data storage device 1118, that communicate with each other via a bus 1132.

The processor 1102 may represent one or more general-purpose processing devices such as a microprocessor, a central processing unit, and/or the like. According to some aspects, the processor 1102 may be a complex instruction set computing (CISC) microprocessor, reduced instruction set computing (RISC) microprocessor, very long instruction word (VLIW) microprocessor, a processor implementing other instruction sets, processors implementing a combination of instruction sets, and/or the like. According to some aspects, the processor 1102 may be one or more special-purpose processing devices such as an application specific integrated circuit (ASIC), a field programmable gate array (FPGA), a digital signal processor (DSP), network processor, and/or the like. The processor 1102 can execute processing logic 1126 for performing various operations and/or steps described herein.

The hardware device 1100 may further include a network interface device 1108, as well as a video display unit 1110 (e.g., a liquid crystal display (LCD), a cathode ray tube (CRT), and/or the like), an alphanumeric input device 1112 (e.g., a keyboard), a cursor control device 11 power 14 (e.g., a mouse, a trackpad), and/or a signal generation device 1116 (e.g., a speaker). The hardware device 1100 may further include a data storage device 1118. The data storage device 1118 may include a non-transitory computer-readable storage medium 1130 (also known as a non-transitory computer-readable storage medium or a non-transitory computer-readable medium) on which is stored one or more modules 1122 (e.g., sets of software instructions) embodying any one or more of the methodologies or functions described herein. For instance, according to particular aspects, the modules 1122 include a 110, neighboring segment data module 115, gateway computing system identification module 120, and emergency stop module 125 as described herein. The one or more modules 1122 may also reside, completely or at least partially, within main memory 1104 and/or within the processor 1102 during execution thereof by the hardware device 1100—main memory 1104 and processor 1102 also constituting computer-accessible storage media. The one or more modules 1122 may further be transmitted or received over a network one or more networks 150 via the network interface device 1108.

While the computer-readable storage medium 1130 is shown to be a single medium, the terms “computer-readable storage medium” and “machine-accessible storage medium” should be understood to include a single medium or multiple media (e.g., a centralized or distributed database, and/or associated caches and servers) that store the one or more sets of instructions. The term “computer-readable storage medium” should also be understood to include any medium that is capable of storing, encoding, and/or carrying a set of instructions for execution by the hardware device 1100 and that causes the hardware device 1100 to perform any one or more of the methodologies of the present disclosure. The term “computer-readable storage medium” should accordingly be understood to include, but not be limited to, solid-state memories, optical and magnetic media, and/or the like.

### System Operation

The logical operations described herein may be implemented (1) as a sequence of computer implemented acts or one or more program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, steps, structural devices, acts, or modules. These states, operations, steps, structural devices, acts, and modules may be implemented in software, in firmware, in special purpose digital logic, and any combination thereof. Greater or fewer operations may be performed than shown in the figures and described herein. These operations also may be performed in a different order than those described herein.

### CONCLUSION

While this specification contains many specific aspect details, these should not be construed as limitations on the scope of any invention or of what may be claimed, but rather as descriptions of features that may be specific to particular aspects of particular inventions. Certain features that are described in this specification in the context of separate aspects may also be implemented in combination in a single aspect. Conversely, various features that are described in the context of a single aspect also may be implemented in multiple aspects separately or in any suitable sub-combination. Moreover, although features may be described above as acting in certain combinations and even initially claimed as such, one or more features from a claimed combination may in some cases be excised from the combination, and the claimed combination may be a sub-combination or variation of a sub-combination.

Similarly, while operations are described in a particular order, this should not be understood as requiring that such operations be performed in the particular order described or in sequential order, or that all described operations be performed, to achieve desirable results. In certain circumstances, multitasking and parallel processing may be advantageous. Moreover, the separation of various components in the various aspects described above should not be understood as requiring such separation in all aspects, and the described program components (e.g., modules) and systems may generally be integrated together in a single software product or packaged into multiple software products.

Many modifications and other aspects of the disclosure will come to mind to one skilled in the art to which this disclosure pertains having the benefit of the teachings presented in the foregoing descriptions and the associated drawings. Therefore, it is to be understood that the disclosure is not to be limited to the specific aspects disclosed and that modifications and other aspects are intended to be included within the scope of the appended claims. Although specific terms are employed herein, they are used in a generic and descriptive sense only and not for the purposes of limitation.

What is claimed is:

1. An industrial control system comprising a plurality of machine segments, the plurality of machine segments comprising a first machine segment comprising:
a segment control system comprising at least a logic controller and an independent safety controller;
one or more safety components;
one or more motors; and
one or more input/output devices, wherein:
the segment control system in communication with one or more safety components, one or more motors, and one or more input/output devices;
the first machine segment is in direct network communication with a second machine segment of the plurality of machine segments; and
the segment control system is configured for:
transmitting, to the second machine segment, first function data for the first machine segment;
receiving, from the second machine segment, second function data for the second machine segment;
receiving, from the second machine segment, identifying data for a gateway computing system in the industrial control system;
controlling operation of the one or more motors independent of the plurality of machine segments;
receiving input/output data from the one or more input/output devices;
monitoring, using the independent safety controller, the one or more safety components;
receiving, from at least one of the second machine segment or the gateway computing system, handling data for a particular item traversing the industrial control system; and
operating the one or more motors based on the handling data.

2. The industrial control system of claim 1, wherein the logic controller is configured for performing each of:
transmitting, to the second machine segment, the first function data for the first machine segment;
receiving, from the second machine segment, the second function data for the second machine segment;
receiving, from the second machine segment, the identifying data for a gateway computing system in the industrial control system;
controlling the operation of the one or more motors independent of the plurality of machine segments; and
receiving the input/output data from the one or more input/output devices.

3. The industrial control system of claim 1, wherein the segment control system is further configured for:
receiving, from at least one of the one or more safety components, the second machine segment, or the gateway computing system, an identification of a safety event; and
in response to receiving the identification of the safety event, causing, by the independent safety controller, a safety response defined by the safety event.

4. The industrial control system of claim 1, wherein:
the one or more motors comprise one or more motor controllers; and
the one or more motor controllers are configured to operate the one or more motors based on at least one of the input/output data, the second function data for the second machine segment, or the handling data.

5. The industrial control system of claim 1, wherein:
the first machine segment is in direct network communication with the second machine segment via a second direct cable run from the second machine segment.

6. The industrial control System of claim 1, wherein the segment control system is further configured for transmitting the input/output data to the second machine segment.

7. The industrial control system of claim 1, wherein:
the second function data for the second machine segment comprises a motor speed for the second machine segment; and
the segment control system is further configured for:
determining a coordinating motor speed based on the motor speed for the second machine segment; and
causing the one or more motors to run at the coordinating motor speed.

8. The industrial control system of claim 1, wherein the gateway computing system comprises at least one of the second machine segment or a third machine segment of the plurality of machine segments.

9. The industrial control system of claim 1, wherein the industrial control system does not comprise a centralized motor control center.

10. A machine segment in an industrial control system, the machine segment comprising:
a segment control system comprising at least a logic controller and an independent safety controller;
one or more safety components;
one or more motors; and
one or more input/output devices, wherein:
the segment control system is in direct network communication with a neighboring machine segment control system via a first network connection;
the independent safety controller is in direct network communication with a neighboring machine segment independent safety controller via a second network connection;
the logic controller is configured to receive input/output data from the one or more input/output devices and transmit the input/output data directly to the neighboring machine segment control system via the first network connection;
the logic controller is configured to receive second input/output data from the neighboring machine segment via the first network connection;
the logic controller is configured to receive identifying data for the neighboring machine segment from the neighboring machine segment via the first network connection; and
the logic controller is configured to control operation of each of the one or more motors based on one or more of the input/output data, the second input/output data, or the identifying data for the neighboring machine segment.

11. The machine segment of claim 10, wherein the logic controller is further configured for:
receiving, from the neighboring machine segment via the first network connection, identifying information for a gateway computing system in the industrial control system;
receiving, from the gateway computing system, handling data for an item traversing the industrial control system; and
modifying the operation of each of the one or more motors based on the handling data at a time that corresponds to the item encountering the machine segment.

12. The machine segment of claim 11, wherein the neighboring machine segment is the gateway computing system.

13. The machine segment of claim 10, wherein the independent safety controller is configured for:
receiving, from at least one of the neighboring machine segment independent safety controller via the second network connection or the one or more safety components, safety event data; and
initiating, in response to receiving the safety event data, an emergency event response based on the safety event data.

14. The machine segment of claim 13, wherein the emergency event response comprises at least one of transmitting the safety event data to a second machine segment via a third network connection or modifying the operation of each of the one or more motors based on the safety event data.

15. The machine segment of claim 10, wherein:
the industrial control system defines a first set of interlocked machine segments and a second set of interlocked machine segments;
the machine segment is in the first set of interlocked machine segments;
the logic controller is configured to receive operation data directly from each of the first set of interlocked machine segments; and
the logic controller is configured to control the operation of each of the one motors in coordinate each of the first set of interlocked machine segments based on the operation data.

16. The machine segment of claim 10, wherein the first network connection and the second network connection are disposed adjacent an outer side of the machine segment.

17. The machine segment of claim 16, further comprising a shroud that encloses at least a portion of the outer side of the machine segment, shielding a first network connection point for the first network connection and a second network connection point for the second network connection.

18. The machine segment of claim 10, wherein the first network connection is the second network connection.

19. An industrial control system machine segment comprising:
a segment control system comprising a safety controller, one or more power components, and a programmable logic controller;
one or more safety components in communication with the safety controller;
one or more motors in communication with the programmable logic controller, the one or more motors comprising one or more motor controllers; and
one or more input/output devices in communication with the programmable logic controller, the one or more input/output devices comprising one or more sensors and at least one input/output coupler providing a link between the one or more sensors and the programmable logic controller, wherein:
the programmable logic controller is in direct network communication with a corresponding programmable logic controller for a second machine segment in the industrial control system;
the one or more power components are configured to receive power directly from at least one of the second machine segment or an industrial control facility power source;
the safety controller is configured to receive safety event data from the one or more safety components or an adjacent machine segment in the industrial control system and, in response, initiate a safety response based on the safety event data;
the programmable logic controller is configured to control operation of the one or more motors via the one or more motor controllers both independent of the industrial control system and based on handling data received from the industrial control system; and
the programmable logic controller is configured to receive input/output data from the one or more input/output devices and transmit at least a portion of the input/output data to at least one of the second machine segment in the industrial control system or a gateway computing system for the industrial control system.

20. The industrial control system machine segment of claim 19, wherein:
the programmable logic controller is configured to transmit first identifying data to the adjacent machine segment and receive second identifying data from the adjacent machine segment; and
the programmable logic controller is further configured to control operation of the one or more motors based on the second identifying data.
